(19) United States
(12) Patent Application Publication
(10) Pub. No.: US 2009/0192810 A1
(43) Pub. Date: Jul. 30, 2009

(54) FRAUD DETECTION SYSTEM & METHOD

(75) Inventors: Alexander Filatov, Longmont, CO (US); Dmitry S. Gorshuny, Longmont, CO (US); Michael Fenton, Longmont, CO (US)

Correspondence Address: MERCHANT & GOULD PC, P.O. BOX 2903, MINNEAPOLIS, MN, 55402-0903, US

(73) Assignee: Parascript, LLC, Boulder, CO (US)

(21) Appl. No.: 12/021,046

(22) Filed: Jan. 28, 2008

(51) Int. Cl. G06Q 99/00

(52) U.S. Cl. 705/1

(57) ABSTRACT

Methods and systems are disclosed for combining the results from multiple fraud detection devices into a single, ordered list of suspect items. The confidence value for each suspect item identified by each fraud detection process may be calculated. Calculated confidence values may be refined by resealing the confidence value. The confidence value of items from multiple lists may then be further refined using a voting process. Use of a voting process takes into account the determinations of each of the fraud detection processes in order to calculate or refine the confidence values associated with each suspect item. After conducting the voting process, the suspect items may be combined into a single suspect list. The new suspect list may be ordered by confidence values. Additionally, the expected loss of each item may be calculated for each suspect item. Suspect lists may also be ordered according to expected loss.

### BACKGROUND

The acceptance of fraudulent items results in significant loss to many industries and consumers. In order to determine the veracity of items, many institutions have employed fraud detection processes. Such processes may identify certain items as potentially fraudulent. Upon identification, these items require further processing in order to determine their authenticity. The further processing may be done by a computer program, or in some situations, manually by experts trained in detection fraud. Both situations are often demanding upon resources.

In order to better identify fraudulent items, many industries employ multiple fraud detection processes. However, each fraud detection process generally identifies different items as being potentially fraudulent, thereby increasing the number of potentially fraudulent items that must be further examined. One solution to this problem has been to disregard a significant number of items identified by the multiple fraud detection processes and accept the items as being authentic. However, under such an approach, many actual fraudulent items are accepted as authentic, thus resulting in loss to both industries and consumers. It is with respect to this general environment that embodiments of the present disclosure have been contemplated.

### SUMMARY

Embodiments of the present disclosure relate to computer implemented systems and methods for producing an ordered suspect list of potentially fraudulent items. In embodiments, one or more fraudulent detection processes are applied to a set of input items to determine the veracity of the input items. In embodiments, the input items may be personal or corporate checks. In other embodiments, the input items may be any type of item that must be authenticated. The one or more fraud detection process may analyze items to produce one or more suspect lists. In embodiments, the one or more suspect lists may be unordered.

Embodiments of the disclosed methods operate upon the one or more suspect lists to produce a single, ordered suspect list. In such embodiments, confidence values may be determined for items on the one or more suspect lists. Confidence values may be determined using historically confirmed fraudulent data and historically flagged suspect data. The confidence values may relate to the likelihood that the suspect item is indeed fraudulent. In other words, the confidence value may relate to the probability of loss for each suspect item if the suspect item is accepted as authentic. In other embodiments, the confidence values may relate to any type of characteristic used in determining veracity.

In embodiments, after a confidence value has been assigned to every item on the one or more suspect lists, a voting process is applied to the one or more lists to determine a new confidence value for each item on the one or more suspect lists. In embodiments, the resulting combined suspect list may be ordered by new confidence values determined using the voting process. In other embodiments, the voting process may rescale the confidence values assigned to each item on the one or more suspect lists. In further embodiments, the expected loss may be calculated for each item on the suspect list. In such embodiments, the combined suspect list may be ordered by the expected loss.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Embodiments of the present invention may be more readily described by reference to the accompanying drawings in which like numbers refer to like items and in which:

FIG. 1 is a flow chart representing an embodiment of a method 100 for producing a suspect list of fraudulent items using a fraud detection process.

FIG. 2 is a flow chart representing an embodiment of a method 200 for determining a confidence value for items on a suspect list.

FIG. 3 is a flow chart representing an embodiment of a method 300 for calculating the confidence value for an item on a suspect list.

FIG. 4 is a flow chart representing an embodiment of a method 400 for ordering a suspect list.

FIG. 5 is a flow chart representing an embodiment of a method 600 for producing an ordered suspect list based upon the output of two fraud detection processes.

FIG. 6 is a flow chart representing an embodiment of a method 700 for determining an expected loss for an item on a suspect list.

FIG. 7 is a functional diagram illustrating a computer environment and computer system 700 operable to execute embodiments of the present disclosure.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

Embodiments of the present disclosure relate to computer implemented methods for producing an ordered suspect list of potentially fraudulent items. In embodiments, one or more fraud detection processes analyze a set of input items to determine the veracity of the input items. A fraud detection process may be transactional-based, image-based, or may utilize any other process or method known in the art to determine the veracity of an item. In embodiments, the input items may be a personal or corporate check. In other embodiments, the input items may be any type of item that must be authenticated. The one or more fraudulent detection process may produce one or more suspect lists. The suspect lists may contain suspect items (e.g., items that the particular fraud detection process identifies as potentially fraudulent). The specific criteria by which each fraud detection process identifies suspect items will vary depending on the type of fraud detection process (e.g., transaction-based) and the thresholds used therein. In embodiments, the one or more fraud detection processes may produce ordered suspect lists. In such embodiments, the suspect lists may be ordered by confidence values associated with each item on the suspect list. The confidence values may relate to the likelihood that the suspect item is indeed fraudulent. In other embodiments, the confidence values may relate to any type of characteristic used in determining veracity. In other embodiments, the one or more fraud detection processes may not associate a confidence value with each item. In still further embodiments, the one or more fraud detection processes may produce unordered suspect lists.

Embodiments of the disclosed methods operate upon the one or more suspect lists to produce a single, ordered suspect list. In such embodiments, confidence values may be determined for suspect items on the one or more suspect lists. In one embodiment, historically confirmed fraudulent data and historically flagged suspect data may be used to calculate confidence values for the suspect items. In another embodiment, the historically confirmed fraudulent data and historically flagged suspect data may be used to calculate confidence values for sub-ranges of data based upon a value associated with the suspect item and a type of suspect situation. In such embodiments, the confidence value may be assigned and/or used to modify the confidence value of any suspect item that falls within a specific sub-range. In other embodiments, the fraud detection processes may have previously determined confidence values for each item on the suspect list. In such embodiments, the confidence values may be rescaled in order to produce more accurate confidence values.

In embodiments, after a confidence value has been assigned to every suspect item on the one or more suspect lists, a voting process is applied to the one or more lists to determine a new confidence value for each item on the one or more suspect lists. In embodiments, the resulting combined suspect list may be ordered by the new confidence values determined in the voting process. In further embodiments, the expected loss may be calculated for each item on the suspect list. In such embodiments, the combined list may be ordered by the expected loss.

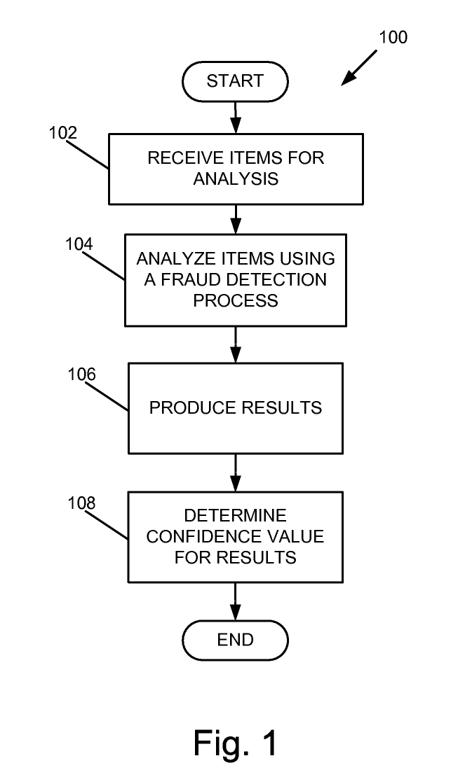

FIG. 1 is a flow chart representing an embodiment of a method 100 for producing a suspect list of possibly fraudulent items using a fraud detection process. Flow begins at step 102 where items are received for analysis. In one embodiment, the items may be checks drawn on an account. In another embodiment, the items may be receipts from credit card purchases. One of skill in the art will appreciate that the items received at step 102 may be any type of item that requires some type of authenticity verification. In other embodiments, the input may be images of or data from the items rather than the actual items. For example, in check verification, the input may be an image of the check or data from the fields of the check (e.g., account number, legal amount, courtesy amount, payee, etc.) In such embodiments, the fraud detection processes operate upon the image representing the item or data contained within the item.

Flow proceeds to step 104 where the items are analyzed using a fraud detection process. In embodiments, the fraud detection process may be an image-based fraud detection process. In such embodiments, the image-based fraud detection process may determine whether the item is potentially fraudulent by analyzing the item for specific suspect situations. For example, if the items relate to check drawn on an account, an image-based fraud detection process may analyze the item for suspect situations such as: signature mismatch, check stock mismatch, disagreement between courtesy and legal amounts, whether the check is a preauthorized draft, whether alterations have been made to the check, or any other suspect situations known to the art. In other embodiments, the fraud detection process may be a transactional-based process. In such embodiments, the transactional-based fraud detection process may analyze the item for suspect situations such as, using checks drawn on an account as an example, unusual check number, unusual velocity of transactions, unusual check amount, or any other suspect situation known to the art. In still other embodiments, other types of fraud detection processes may analyze items based upon other suspect situations and/or features specific to the type of fraud detection process. One of skill in the art will appreciate that embodiments of the systems and methods disclosed herein will operate regardless of the type of fraud detection process used and that any number of different suspect situations may be employed with the embodiments disclosed herein.

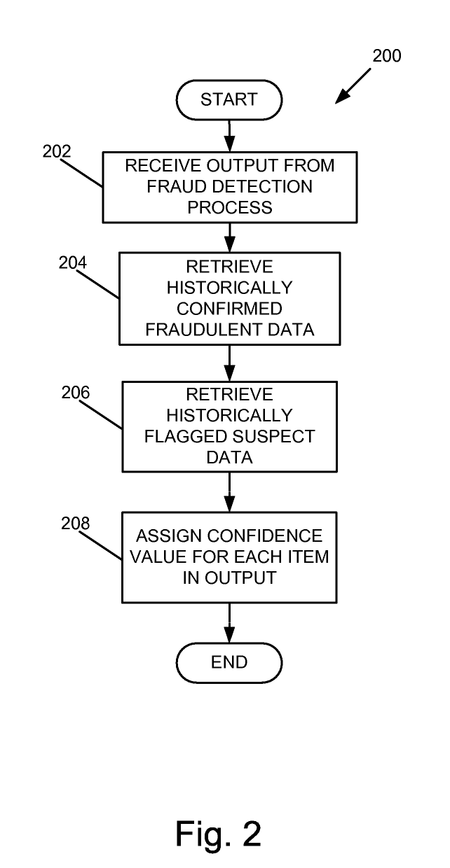

After the fraud detection process or processes analyze the received items, images of items, or data from the items, flow proceeds to step 106 where the fraud detection process produces the results of the analysis. In embodiments, the results may be outputted in the form of a suspect list. The suspect list may be a list of items that the fraud detection process determined were fraudulent or potentially fraudulent. Flow then proceeds to step 108, where a confidence value is determined for each item in the suspect list. In some embodiments, the fraud detection process may assign a confidence value to each item on the suspect list. In other embodiments, a confidence value may not be assigned to the items on the suspect list. In such embodiments, confidence values are determined using historical information. An example of step 108 is discussed further with respect to FIG. 2. Although specific embodiments of producing a suspect list have been provided with respect to FIG. 1, the specific embodiments have been disclosed solely for illustrative purposes. One of skill in the art will appreciate that suspect lists may be generated in any way known to the art.

FIG. 2 is a flow chart representing an embodiment of a method 200 for calculating a confidence value for items on a suspect list. Flow begins at step 202, where the method receives the output from a fraud detection process. In embodiments, the output may be a suspect list generated by a fraud detection process. One of skill in the art will recognize that the output may be generated by any fraud detection process known to the art.

Flow proceeds to step 204, where historically confirmed fraudulent data is retrieved. In embodiments, the historically confirmed fraudulent data contains a history of confirmed fraudulent items (e.g., past items that were subsequently confirmed to be fraudulent). In embodiments, the historically confirmed fraudulent items are associated with a suspect feature such as suspect situations identified by a detection process or processes, or types of fraud. Additionally, in embodiments, the historically confirmed fraudulent item may also be associated with a value related to the item. For example, if the fraudulent item was a check, the value associated with it may be the value of the check or the difference between the courtesy amount and legal amount. In other embodiments, the value may incorporate additional expenses related to resolving a customer claim, such as personnel expenses or lost account revenue. In further embodiments, the historically confirmed fraudulent data may be associated with a time, such as a time that the item was received, a time indicated by the item, etc. Table 1 provides an example historically confirmed fraudulent data for a transactional-based fraud detection system for checks. For ease of illustration, the historically confirmed fraudulent data contains only 10 entries, however one of skill in the art will readily appreciate that, in embodiments, the history file may be larger or smaller, or may be composed of multiple files.

TABLE 1
Example Historically Confirmed Fraudulent Data File for
Transactional-Based Fraud Detection

| CHECK | SUSPECT SITUATION | VALUE |
|---|---|---|
| A | Velocity of Transactions | $52.00 |
| B | Check Amount | $10,000.00 |
| C | Velocity of Transactions | $123.00 |
| D | Velocity of Transactions | $33.00 |
| E | Velocity of Transactions | $44.40 |
| F | Check Number | $285.00 |
| G | Velocity of Transactions | $93.00 |
| H | Check Number | $2.50 |
| I | Velocity of Transactions | $497.00 |
| J | Check Number | $111.00 |

Table 1 is an example of historically confirmed fraudulent data containing 10 entries for checks ‘A’-‘I’ processed over a particular time period. While Table 1 illustrates the historically confirmed fraudulent data as a table, in other embodiments the confirmed fraudulent data may take any form (e.g., lists, records, etc). Each check in the history file was previously confirmed fraudulent, for example, using manual verification, account-holder confirmation, computer verification, or any other type of verification. One of skill in the art will appreciate that there are a number of manual and/or computer aided methods to confirm a check is indeed fraudulent; however, the actual manner in which the check was confirmed fraudulent has no bearing upon embodiments of the present disclosure. For simplicity's sake, assume that the 10 entries for checks ‘A’-‘I’ comprise the entire historically confirmed fraudulent data.

As previously mentioned, the fraudulent item may be associated with one or more suspect situations. For example, the suspect feature associated with check ‘A’ is ‘Velocity of Transactions’ (i.e., unusual number of check written within a given time period). In embodiments, the fraudulent item may be associated with the suspect feature that was used by the fraud detection system to identify or flag the item as potentially fraudulent. For example, check ‘A’ was flagged as potentially fraudulent due to its unusual ‘Velocity of Transactions’. In embodiments, there can be several suspect reasons used to indicate a suspect item. In further embodiments, complex suspect features (e.g., a combination of suspect reasons) may be used to identify a suspect item. Additionally, each fraudulent item may be associated with a value. In the example provided in Table 1, each fraudulent item is a check; therefore the value associated with the fraudulent item is the dollar value represented by check. For example, the value of check ‘A’ is ‘$52.00.’ In other embodiments additional costs may be taken into account such as, for example, indirect losses accrued in determining whether the suspect item is indeed fraudulent or other costs associated with the item being fraudulent. In other embodiments, if the fraudulent item is an item other than a check, another type of value may be associated with the item. In embodiments, the historically confirmed fraudulent data may be analyzed to determine characteristics of the data (e.g., in the example of Table 1, six of the ten entries were identified by unusual ‘Velocity of Transactions’).

While Table 1 illustrates an example confirmed fraudulent data for a transaction-based fraud detection process, confirmed fraudulent data may include different types of data for different types of fraud detection process. For example, Table 2 illustrates an example confirmed fraudulent data file that may be used with an image-based fraud detection process for checks processed during a particular time period.

TABLE 2
Example Confirmed Fraudulent Data for Image-Based Fraud Detection

| | SUSPECT | CONFIDENCE | |
|---|---|---|---|
| CHECK | SITUATION | VALUE | AMOUNT |
| A | Alterations | .9 | $311.00 |
| B | Signature Mismatch | .8 | $222.00 |
| C | Signature Mismatch | .7 | $40.00 |
| D | Amount Mismatch | .8 | $50.30 |
| E | Alterations | .8 | $19.83 |
| F | Amount Mismatch | .6 | $2,012.00 |
| G | Alterations | .5 | $1000.00 |
| H | Signature Mismatch | .9 | $3.15 |
| I | Alterations | .8 | $19.84 |
| J | Signature Mismatch | .7 | $963.00 |

Table 2 contains the ‘CHECK’, ‘SUSPECT SITUATION’, and ‘AMOUNT’ data as was included in Table 1; but adds additional ‘CONFIDENCE VALUE’ data. As with Table 1, the same type of information can be derived from Table 2 (e.g., 40% of fraudulent items identified by ‘Alterations’, 40% identified by ‘Signature Mismatch, and 20% identified by ‘Check Amount’). In embodiments, the confidence values may be expressed using different scales depending on the suspect situation (e.g., the confidence value for ‘Signature Mismatch’ may be a value between 1 and 100). Confidence values may also be expressed as functions. Again, in embodiments this type of information may be processed and extracted by the method 200, or may be previously calculated by another method or application and retrieved by the method 200 at step 204. However, Table 2 illustrates an example of how history files may differ depending on the type of fraud detection process used to analyze the items of interest. For example, Table 2 incorporates unique ‘SUSPECT SITUATIONS’ (e.g., ‘Signature Verification’) as well as unique data (e.g., ‘CONFIDENCE VALUES’). In embodiments, there may be multiple suspect situations associated with multiple confidence values. While Table 2 has been described as including confidence values from an image-based fraud detection process, in other embodiments, the image-based fraud detection process may not include confidence values. One of skill in the art will appreciate that the type of confirmed fraudulent data may vary, as illustrated by Table 1 and Table 2, depending on the process used and information retrieved in flagging suspects and confirming fraudulent items. Furthermore, while Table 1 and Table 2 illustrate two separate files containing confirmed fraudulent data for two different fraud detection process, one of skill in the art will readily appreciate that confirmed fraudulent data for two or more processes may be stored in a single file or datastore. In the latter case a single suspect item may be associated with suspect features from multiple detectors.

In further embodiments, the historically confirmed fraudulent data may contain statistics related to the historical data rather than data about the individual items themselves. Table 3 is an example of a historically confirmed fraudulent data file that contains statistical information. As demonstrated, such a file may contain data related to a ‘TIME PERIOD’, ‘SUSPECT SITUATION’, and ‘NUMBER OF FRADULENT ITEMS’. In this example, the historically fraudulent data contains information related to the total number of fraudulent items identified by a specific suspect situation. For example, in ‘TIME PERIOD’ ‘1’, ‘444’ confirmed fraudulent items were identified by unusual ‘Velocity of Transactions’. One of skill in the art will appreciate that in other embodiments, the historically confirmed fraudulent data may not be broken down into time periods. For example, the historically confirmed fraudulent data may contain statistical data related to the total number of confirmed fraudulent items ever identified by a suspect situation. In other embodiments, the historically confirmed fraudulent data may comprise percentages rather than number (e.g., 22% of confirmed fraudulent items were identified by unusual ‘CHECK NUMBER’). In still other embodiments, the historically confirmed fraudulent data may contain data related to a value of the items instead of a suspect situation (e.g., values between 1-100, 100-500, etc.) One of skill in the art will appreciate that, in such embodiments, the historically confirmed fraudulent data may contain any type of statistical information and/or may be preexisting.

TABLE 3
Example Historical Confirmed Fraudulent Data with Statistics

| TIME | | NUMBER OF |
|---|---|---|
| PERIOD | SUSPECT SITUATION | FRADULENT ITEMS |
| 1 | Velocity of Transactions | 444 |
| 1 | Check Amount | 1,227 |
| 2 | Check Number | 78 |
| 2 | Velocity of Transactions | 21 |
| 3 | Check Amount | 543 |

Flow proceeds to step 206 where the output is compared to historically flagged suspect data. In embodiments, historically flagged suspect data may include data related to the total number of suspects flagged by a fraud detection process, the number of items of each suspect type flagged (for example, the number of items flagged due to ‘Velocity of Transactions’, ‘Check Amount’, or a combination of both suspect situations in a transactional-based fraud detection system). In other embodiments, the historically flagged suspect data may include other per-image data (e.g., when using an image-based transactional process) or statistical data related to historical output lists, such as the time the item was received or processed. In embodiments, the flagged data includes similar data as that was included in the confirmed fraudulent data, however the data relates to all suspect items flagged by the fraud detection process, whereas the confirmed fraudulent data relates to the items that were later determined fraudulent. In embodiments, the historically flagged suspect data and the historically confirmed fraudulent data are limited to the same historical time frame. In other embodiments, the flagged data may be preexisting.

An example of historically flagged suspect data follows. Flagged data may include historical information about the results of a fraud detection process. As an example, a fraud detection process may have flagged 10,000 suspect items. Of these 10,000 suspect items, 3,500 items were flagged for an unusual ‘Velocity of Transactions’ and another 2,000 items were flagged for an unusual ‘Check Number.’ In some embodiments, flagged data may contain statistical data related to the output of the fraud detection process, e.g., 2,000 ‘Check Number’ items, 35% ‘Velocity of Transactions’, etc. One of skill in the art will appreciate that the flagged suspect data may contain any type of data related to suspect items identified by a fraud detection process.

In other embodiments, the historically flagged suspect data may also contain information related to a time period in which the items were flagged. For example, the time period might relate to the last six months, in which case any data included in the historically flagged suspect data relates to suspect items processed by the fraud detection process within the last six months. In other embodiments, the historically flagged suspect data may contain data related to all the suspect items ever processed by the fraud detection process. In such embodiments, a time of process may be associated with every suspect item. Using the time of process data, applications accessing the flagged data information may select flagged data about suspect items according to when they were processed. For example, an application or method receiving the flagged data may desire to analyze only the data related to suspect items processed within the last month. The application would be able to select only flagged data related to suspect items processed within the last month based upon the time of process data associated with the flagged data. In embodiments, the time period used for the historically flagged suspect data is the same time period for the historically confirmed fraudulent data.

After retrieving the historically confirmed fraudulent data and the historically flagged suspect data in steps 204 and 206, respectively, flow proceeds to step 208 where a confidence value is assigned for the output from the fraud detection process. In embodiments, the output from the fraud detection process may be a suspect list and a confidence value may be calculated for each suspect item in the suspect list. In another embodiment, the suspect list may be divided into ranges and/or categories (e.g., all items with a suspect situation that is ‘Velocity of Transactions’ and/or a value between 100 and 1,000) and a confidence value may be calculated for each range. In such an embodiment, every item located within the range and/or category is assigned the calculated confidence value for the range and/or category. In embodiments, the confidence value may be calculated as an estimate of the probability for the suspect items to be fraudulent or any monotonic function of that probability. In embodiments, the confidence value may be calculated using historically confirmed fraudulent data and/or historically flagged suspect data (e.g., by correlating past results). While embodiments of FIG. 2 have been described with respect to a transactional-based and image-based fraud detection process, one of skill in the art will recognize that any other type of fraud detection process may be utilized with the illustrated embodiments. Additionally, while FIG. 2 has been described in sequential order with respect to steps 204 and 206, one of skill in the art will appreciate that steps 204 and 206 may be performed in reverse order or simultaneously in embodiments of the present disclosure. In other embodiments, steps 204, 206, and 208 may be executed in a preliminary training phase when some or all of the historical data (confirmed fraudulent and flagged suspect data) may already be available and then the training results applied to one or more suspect lists produced at a later time.

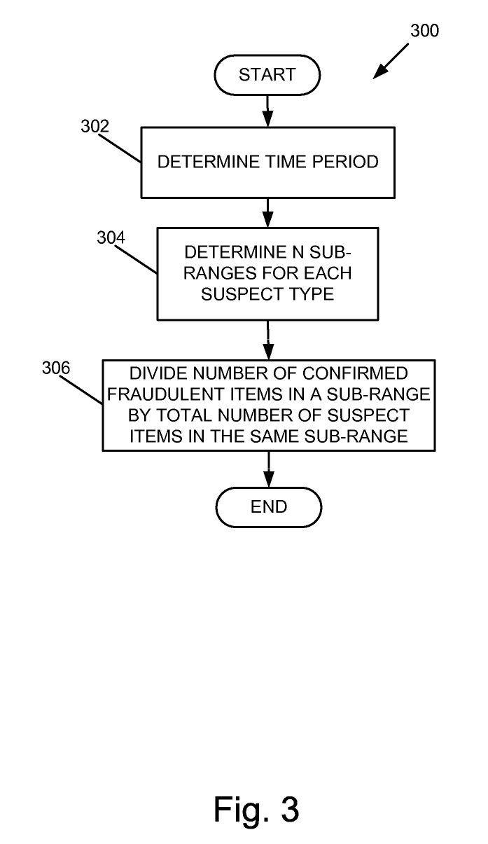

FIG. 3 is a flow chart representing an embodiment of a method 300 for calculating the confidence value for an item on a suspect list, such as in step 208 (FIG. 2). Flow begins at step 304 where a time period is determined. Because the amount of historically confirmed fraudulent data and/or historically flagged suspect data may be large, determining a time period places a limit on the amount of data used. Additionally, trends in fraudulent items may change over time. By setting a time period for the transactions, the method is able to focus on the most relevant trend, thereby producing a more accurate confidence value. In one embodiment, the time period may be determined based upon the time period in which the suspect items were received. Again, one of skill in the art will appreciate that a time period may be determined in any manner of determining a time period known to the art. In other embodiments, it may be impossible to determine a time period. For example, if the historical data (confirmed fraudulent or flagged suspect) is not associated with a time period, it may be impossible to determine a time period because such information is missing. In such embodiments, the time period may correspond to the entire time period of the history file or step 302 may be skipped.

Flow then proceeds to step 302, where, in embodiments, a number of sub-ranges are determined. For example, sub-ranges may be divided by suspect situation, e.g., ‘Velocity of Transactions’, ‘Signature Mismatch’, etc., or a combination thereof. In other embodiments, sub-ranges may also be determined by amount, such as a check amount if suspect items relate to check. For example, in such a situation sub-ranges may include ranges from 0-$100, $101-$500, etc., until all check values are placed in a sub-range. In embodiments, sub-ranges may be determined based upon the distribution of values (e.g., by sampling the data to determine a best distribution in which to divide the data). In embodiments where there is confidence value associated with suspect situations, the confidence value could be split into sub-ranges (0-0.05, 0.05-0.4, 0.4-0.6, etc).

In embodiments, suspect items may then be organized and grouped according to sub-range. For example, in an embodiment, sub-ranges may be determined by both category and amount. The suspect items may be grouped into categories and then each category may be divided by into sub-ranges by value. As an example, one grouping may be all suspect items with a suspect situation with an amount within a certain range (e.g., suspect situation is ‘Velocity of Transactions’ and amount is $100-$500). One of skill in the art will appreciate that sub-ranges may be determined in any manner known to the art.

The number of sub-ranges determined in step 304 relates to the accuracy of the confidence value assigned and/or calculated in step 306. For example, a large number of sub-ranges may be advantageous for purposes of statistical relevance. However, this must be balanced by the fact that a smaller number of sub-ranges leads to a more refined probability calculation. Thus, in embodiments, these two competing factors may be considered in determining the number of sub-ranges to divide the data into.

In other embodiments, the sub-ranges may be predetermined. This may be a result of the historical data. For example, referring to Table 3, the historical data is divided by ‘TIME PERIOD’ and ‘SUSPECT SITUATION’. In embodiments where the historical data is previously categorized (e.g., by ‘TIME PERIOD’ and ‘SUSPECT SITUATION’), the sub-ranges determined in step 304 may be limited by such categorization.

Flow proceeds to step 306, where the number of confirmed fraudulent items, from the historically confirmed fraudulent data (FIG. 2), within a sub-range and during the determined time period is divided by the total number of items, from the historically flagged suspect data (FIG. 2), within the same sub-range and during the same determined time period. The resulting value represents the estimate of the probability of being fraudulent and may be used as a confidence value for suspect items that fall within the sub-range and time period. In other embodiments, different methods of estimating the probability of being fraudulent may be used, such as statistical reconstruction of dependency between probability and all known parameters of suspect item. For example, if the suspect items already had a confidence value (e.g., the fraud detection process previously assigned a confidence value to the suspect item) and that value is already in a probability scale, the value computed in step 306 may be rescaled by multiplying the value computed by the previously assigned confidence value. In other embodiments, if the suspect items did not already have a previous confidence value, the value determined in step 306 may be assigned to the value. For example, if the output from a fraud detection system is in a binary form (e.g., suspect or normal) a confidence value of 1 may be associated with every item identified as suspect. Multiplying the value calculated in step 306 by 1 results in a confidence value equal to the value generated at 306. Thus, in such embodiments, the value calculated at step 306 may be the confidence value for many, if not all, of the suspect items grouped in a particular sub-range. In further embodiments, the resulting value may be used in other calculations to determine a confidence value. While FIG. 3 discloses a specific method used to calculate a confidence value, one of skill in the art will appreciate that other methods of calculating a confidence value may be used with embodiments disclosed herein.

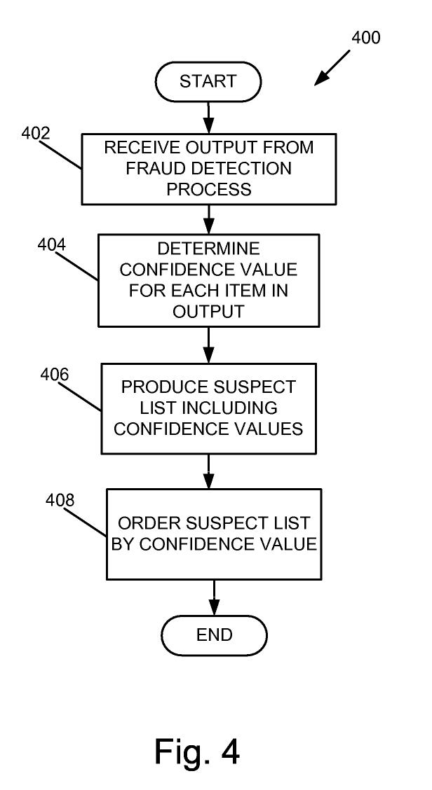

In embodiments, upon calculating the confidence value for each item in the output from the fraud detection process, the items in the output may be ordered. FIG. 4 is a flow chart representing an embodiment of a method 400 for ordering a suspect list. Flow begins at step 402 where the method receives the output from a fraud detection process. In embodiments, the fraud detection process may be a transactional-based process, an image-based process, or any other fraud detection process known to the art. In embodiments, the fraud detection may produce a suspect list, as described in FIG. 1. Flow proceeds to step 404 where, in embodiments, confidence values are produced for each item in the output from the fraud detection process. In embodiments, a confidence value is determined and associated with each suspect item on a suspect list, as previously described in FIG. 3. In yet another embodiment, the output from the fraud detection process may include confidence values. In such embodiments, new confidence values may be calculated for each item using different methods known to the art or the confidence values may be rescaled.

Flow proceeds to step 406, where the method produces a suspect list including confidence values. In embodiments, the suspect list produced in step 406 includes confidence values for each suspect item in the suspect list. Flow then proceeds to step 408 where the suspect list is ordered by confidence values. In one embodiment, the suspect list may be ordered from highest confidence value to lowest confidence value. In another embodiment, the confidence value may be ordered from lowest confidence value to highest confidence value. In further embodiments, the ordered suspect list is used to determine which suspect items require further analysis. For example, suspect items with a high confidence value may have a higher probability of being actually fraudulent. In this situation, suspect items with a high confidence value should be further analyzed. The ordered suspect list provides an efficient mechanism for determining which suspect items require further analysis. In other embodiments, a threshold may be determined. The threshold may be predetermined or may be determined at step 408 based upon the characteristics of the output and/or suspect values. In embodiments, multiple thresholds may be determined. For example, separate threshold may be determined for each suspect type. In embodiments where a threshold is used, suspect items may only be included on the ordered suspect list if the confidence value meets the threshold requirement.

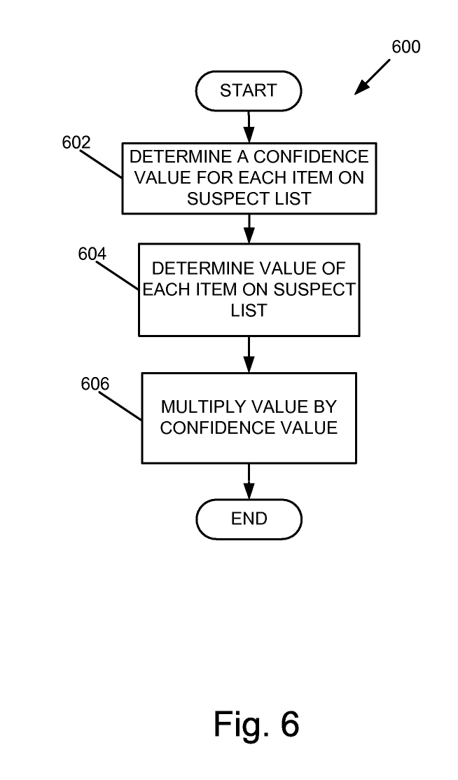

In embodiments, the suspect list may be passed as input to another application. In this embodiment, the application may use the ordered suspect list to perform further analysis on suspect items included on the suspect list. In further another embodiment, the suspect list may be stored for later use. In yet another embodiment, the suspect list may provide guidance as to which suspect items require manual verification. While the ordering of suspect lists has been described with reference to confidence values, one of skill in the art will recognize that suspect lists may be ordered by any other method known to the art. For example, suspect items may be ordered according to probability of loss, expected amount of loss (described herein with respect to FIG. 6), or any other characteristic known to the art.

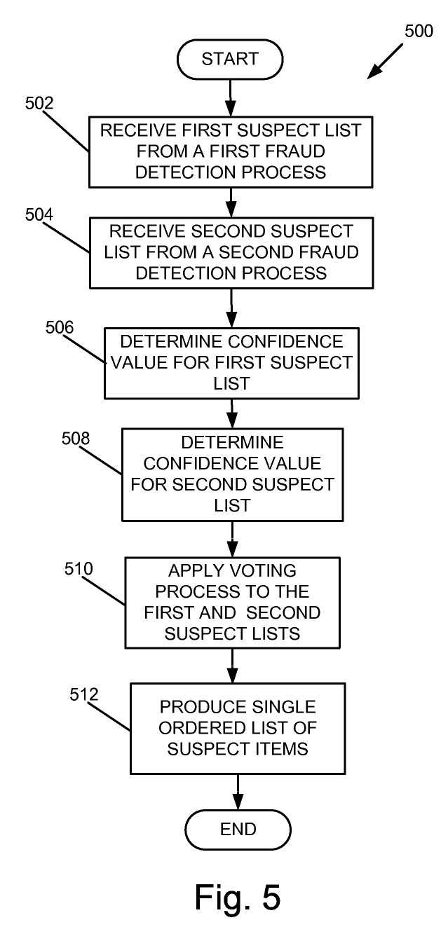

While the embodiments disclosed thus far have focused on producing an ordered suspect list based upon a single fraud detection process, the results of multiple fraud detection processes may be combined into a single ordered list. Combining multiple suspect lists identified by multiple fraud detection processes into a single, ordered suspect list results in a more accurate listing of potentially fraudulent items. FIG. 5 is a flow chart representing an embodiment of a method 500 for producing an ordered suspect list based upon the output of two fraud detection processes. FIG. 5 is described using the output of two fraud detection processes for ease of description. One of skill in the art will recognize that any number of fraud detection processes may be utilized with embodiments disclosed herein. Flow begins at step 502 where the method receives the output from a first fraud detection process. In embodiments, the output from the first fraud detection process may be a suspect list. In other embodiments, the output from the first fraud detection process may be any form of output known to the art. Flow proceeds to operation 504 where the method receives a second output from a second fraud detection process. Again, in embodiments, the output from the second fraud detection process may be a second suspect list. In other embodiments, the second fraud detection output may be any form of output known to the art. In embodiments, the first and second outputs may be in the same form. In other embodiments, the first and second outputs may take different forms.

In embodiments, the second output may be produced by a second fraud detection process operating on the same input as a first fraud detection process. In other embodiments, the second output list may be produced by operating on a subset of the input used by the first detection process. For example, the second fraud detection process may receive as input the suspect items identified by the first fraud detection process. In such embodiments, the first fraud detection process may operate using a relaxed threshold in order to produce a larger set of suspect items.

In yet another embodiment, a confidence value may be associated with each item of the first or second outputs. In other embodiments, confidence values may not be associated with each item of the first and second outputs. In further embodiments, a confidence value may be associated with items of one of the first or second outputs but not the other. One of skill in the art will recognize that embodiments of the present disclosure will operate regardless of whether the output from the fraud detection processes include previously determined confidence values.

Flow proceeds to operation 506 where confidence values are determined for the first suspect list. In embodiments, confidence values may be calculated as described with respect to FIG. 3, or by any other method of determining confidence values known to the art. In other embodiments, confidence values may be determined for an output other than a suspect list. If the first output already has a confidence value associated with it, in embodiments, the confidence values may be rescaled at step 506. The confidence values may be rescaled according to the embodiments disclosed with respect to step 306 (FIG. 3), or with any other method of resealing values known to the art (e.g., adjusting the values based upon a probability scale). In yet another embodiment, the previously determined confidence value may be accepted by the method at step 506. In further embodiments, a confidence value may be determined for the output as a whole, for groups of items associated with a specific suspect type, or separately for each item of the output.

At step 508, confidence values are determined for the second suspect list. Again, in embodiments, confidence values may be calculated as described with respect to FIG. 3, or by any other method of determining confidence values known to the art. In other embodiments, confidence values may be determined for an output other than a suspect list. If the second output already has a confidence value associated with it, in embodiments, the confidence values may be rescaled at step 508. The confidence values may be rescaled according to the embodiment disclosed with respect to step 306 (FIG. 3), or with any other method of rescaling values known to the art (e.g., adjusting the values based upon a probability scale). In yet another embodiment, the previously determined confidence value may be accepted by the method at step 508.

Flow proceeds to operation 510 where a voting process is applied to the first and second suspect lists. In embodiments, the voting process may be used to adjust the confidence values associated with each list according to the separate determinations of the first and second input processes. In embodiments, if confidence values were previously determined for the fist and second suspect lists, operations 506 and 508 may be skipped, and confidence values for the suspect items may be determined using the voting process of operation 510.

In an embodiment with two suspect lists, the voting process may produce confidence values based on three separate situations. First, if the suspect item is on the first list but not the second list, voting process may simply leave the confidence value to the suspect item unchanged. For example, the voting process may apply the following formula in this situation to derive a confidence value:

F(C_{1, 0})=C₁

where F( ) is a function which receives as inputs a confidence value of a suspect item from a first suspect list and a second suspect list and outputs a confidence value based upon the inputs and C₁ is the confidence value of the suspect item from the first confidence list. In this embodiment, if the suspect item only appears on one suspect list, the confidence value assigned to the suspect item remains unchanged. In other embodiments, voting process may apply a penalty to the confidence value because the suspect item only appeared on one suspect list. In other embodiments, the voting process may increase the confidence value of the suspect item when it only appears on a single list. One of skill in the art will appreciate that there are numerous ways of calculating a confidence value in this situation, all of which may be practice with the embodiments disclosed herein.

Second, if the suspect item is on the second list but not the first list, voting process, in embodiments, may simply leave the confidence value to the suspect item unchanged. For example, the voting process may apply the following formula in this situation to derive a confidence value:

F(0, C₂)=C₂

where F( ) is a function which receives as inputs a confidence value of a suspect item from a first suspect list and a second suspect list and outputs a confidence value based upon the inputs and C₂ is the confidence value of the suspect item from the second confidence list. Again, if the suspect item only appears on one suspect list, the confidence value assigned to the suspect item remains unchanged. As previously mentioned, in other embodiments, voting process may apply a penalty to the confidence value because the suspect item only appeared on one suspect list. In other embodiments, the voting process may increase the confidence value of the suspect item when it only appears on a single list. One of skill in the art will appreciate that there are numerous ways of calculating a confidence value in this situation, all of which may be practice with the embodiments disclosed herein.

Third, in embodiments, if the suspect item is on both the first and second suspect lists, the voting process may determine confidence values by adding confidence value from the first list to the second list and then subtracting the product of the first and second confidence values from the result. For example, the voting process may apply the following formula to calculate confidence values:

F(C₁,C₂)=(C₁+C₂)−(C₁×C₂)

where F( ) is a function which receives as inputs a confidence value of a suspect item from a first suspect list and a second suspect list and outputs a confidence value based upon the inputs, C₁ is the confidence value of the suspect item from the first confidence list, and C₂ is the confidence value of the suspect item from the second confidence list. While specific embodiments of a voting process have been disclosed herein, one of skill in the art will recognize that any voting process known to the art may be employed with the embodiments of the present disclosure.

In embodiments, the confidence values resulting from the voting process employed at step 510 may be rescaled. In one embodiment, the confidence values may be rescaled using the method described with respect to step 306 (FIG. 3). In other embodiments, the confidence values may be rescaled. In further embodiments, any method of rescaling values known in the art may be employed in conjunction with step 510. In yet another embodiment, the voting process employed at step 510 may be used to rescale confidence valued previously assigned to suspect items.

After the confidence values are determined and/or adjusted at step 510, flow proceeds to step 512 where a single suspect list is produced. In embodiments, the single suspect list is produced by combining the first and second outputs produced by the first and second fraud detection processes. In further embodiments, the single suspect list is ordered by confidence value. In still further embodiments, a confidence value may be determined for the output as a whole, for groups of items associated with a specific suspect type, or separately for each item of the output. As previously described with reference to FIG. 4, in one embodiment, the suspect list may be ordered from highest confidence value to lowest confidence value. In another embodiment, the confidence value may be ordered from lowest confidence value to highest confidence value. In further embodiments, the ordered suspect list is used to determine which suspect items require further analysis. For example, suspect items with a high confidence value may have a higher probability of being actually fraudulent. In this situation, suspect items with a high confidence value should be further analyzed. The ordered suspect list provides an efficient mechanism for determining which suspect items require further analysis. In other embodiments, a threshold may be determined. The threshold may be predetermined or may be determined at step 512 based upon the characteristics of the output and/or suspect values. In embodiments, multiple thresholds may be determined. For example, separate threshold may be determined for each suspect type. In embodiments where a threshold is used, suspect items may only be included on the ordered suspect list if the confidence value meets the threshold requirement.

In embodiments, the suspect list may be passed as input to another application. In this embodiment, the application may use the ordered suspect list to perform further analysis on suspect items included in the suspect list. In further another embodiment, the suspect list may be stored for later use. In yet another embodiment, the suspect list may provide guidance as to which suspect items require manual verification. While the ordering of suspect lists has been described with reference to confidence values, one of skill in the art will recognize that suspect lists may be ordered by any other method known to the art. For example, suspect items may be ordered according to probability of loss, expected amount of loss (described herein with respect to FIG. 6), or any other characteristic known to the art.

FIG. 6 is a flow chart representing an embodiment of a method 600 for determining an expected loss for an item on a suspect list. Flow begins at step 602 where a confidence value is determined for each item on the suspect list. The confidence value may be determined as disclosed herein with respect to FIGS. 2, 4, and 5, or by any other method of determining probability of loss known to the art. In embodiments where the confidence value for the suspect item has been previously determined, for example, by a fraud detection process, step 602 may be skipped.

Flow proceeds to operation 604 where the value of each suspect item is determined. In embodiments, the value of the suspect item may be determined with reference to historically confirmed fraudulent data or historically flagged suspect data (FIG. 2). In other embodiments, the value of a suspect item may be determined by analyzing the suspect item or by any other method of determining value known to the art. In embodiments, the value of an item may be a dollar amount. For example, if the suspect item represents a check drawn on an account, the value of the suspect item may be the amount that the check is drawn for. In other embodiments, the value may be the difference between the legal and courtesy values. In yet another embodiment, the value may be the estimated total of direct and indirect losses if the fraudulent transaction is completed and later detected. In other embodiments, the value of a suspect item may comprise any other type of value associated with items or accounts.

Flow proceeds to step 606 where the expected loss is calculated by multiplying the value associated with a suspect item by the confidence value associated with the item. In embodiments, this value may be used to order the suspect list. Ordering suspect list by expected loss provides a beneficial way of determining which items to give priority if further fraudulent analysis is required (e.g., analysis by a separate application or manually). For example, with respect to checks drawn on an account, a first item may have a 95% of being fraudulent with a value of $10. A second check may have only a 5% chance of being fraudulent but a value of $10,000. If these items are ordered by confidence value or probability of loss, the first check clearly has priority over the second. However, calculating the expected loss using the method disclosed in FIG. 6, the expected loss associated with the first check is $9.50 while the expected loss associated with the second check is $500. Thus, while the first check is much more likely to be fraudulent, if the check is accepted the resulting loss is miniscule. On the other hand, the second check is more likely to be authentic, however if the check is fraudulent, the expected loss is much more significant. By ordering the suspect items by expected loss, resources can be more efficiently utilized to minimize the losses resulting from accepting fraudulent items.

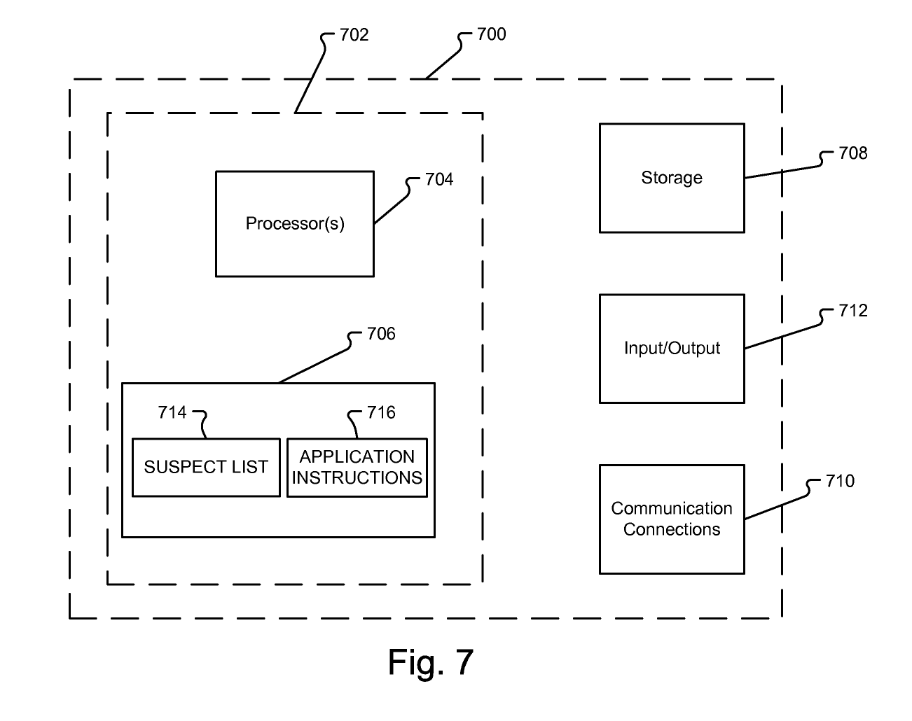

With reference to FIG. 7, an embodiment of a computing environment for implementing the various embodiments described herein includes a computer system, such as computer system 700. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 700 comprises at least one processing unit or processor 704 and system memory 706. The most basic configuration of the computer system 700 is illustrated in FIG. 7 by dashed line 702. In some embodiments, one or more components of the described system are loaded into system memory 706 and executed by the processing unit 704 from system memory 706. Depending on the exact configuration and type of computer system 700, system memory 706 may be volatile (such as RAM), non-volatile (such as ROM, flash memory, etc.), or some combination of the two.

Additionally, computer system 700 may also have additional features/functionality. For example, computer system 700 includes additional storage media 708, such as removable and/or non-removable storage, including, but not limited to, magnetic or optical disks or tape. In some embodiments, software or executable code and any data used for the described system is permanently stored in storage media 708. Storage media 708 includes volatile and non-volatile, removable and non-removable media implemented in any method or technology for storage of information such as computer readable instructions, data structures, program modules, or other data. In embodiments, mammogram images and/or results of probability determination are stored in storage media 708.

System memory 706 and storage media 708 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information and which is accessed by computer system 700 and processor 704. Any such computer storage media may be part of computer system 700. In some embodiments, mammogram images and/or results of probability determination are stored in system memory 706. In embodiments, system memory 706 and/or storage media 708 stores data used to perform the methods or form the system(s) disclosed herein, such as historically confirmed fraudulent data, historically flagged suspect data, probability distributions, etc. In embodiments, system memory 706 would store information such as suspect lists 714 and application instructions 716. In embodiments, suspect lists 714 may contain suspect lists produced by a fraud detection process. Application instructions 716, in embodiments, stores the procedures necessary to perform the disclosed methods and systems. For example, application data 716 may include functions or processes for calculating probability of loss or confidence values, resealing confidence values, voting procedures, etc.

Computer system 700 may also contain communications connection(s) 710 that allow the device to communicate with other devices. Communication connection(s) 710 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, mammogram images and or determinations of probability results may be transmitted over communications connection(s) 710.

In some embodiments, computer system 700 also includes input and output connections 712, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 712 are used to display the information as described herein. All these devices are well known in the art and need not be discussed at length here.

In some embodiments, the component described herein comprise such modules or instructions executable by computer system 700 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 700 is part of a network that stores data in remote storage media for use by the computer system 700.

An illustration of an embodiment of the method and system at work will aid in fully understanding an embodiment of the present disclosure. The following illustration is intended to provide a description of an embodiment of the disclosed systems and methods and is not intended to be used to limit the scope of the claimed subject matter. In embodiments, a financial institution may use multiple fraud detection processes (e.g., a transactional-based process and an image-based process) in order to authenticate the checks that the institution receives. Each of these processes may produce a suspect list identifying checks that may be fraudulent. The multiple fraud detection processes may operate on the same input, or may operate on the output of a first fraud detection process. In embodiments where the fraud detection processes operate on the output of the first fraud detection process, the threshold of the first fraud detection process may be relaxed in order to produce more suspect items.

Once the multiple fraud detection processes have produced multiple suspect lists, embodiments of the present disclosure may operate on the multiple suspect lists. In embodiments, confidence values may be determined for each suspect list that does not include confidence values. Confidence values may be determined using methods described with regard to FIGS. 2, 3, 4 and 5. For example, in embodiments, the suspect items may be grouped according to suspect type and value. The value may relate to any value associated with the suspect item and. Furthermore, the value may be divided into multiple sub-ranges. For example, if the suspect items are checks, the value may correspond to check amounts, and sub-ranges may be determined for the amount (e.g., 0-$100, $100-$1,000, etc.) Based upon the sub-ranges, confidence values may be calculated using information such as historically confirmed fraudulent data and historically flagged suspect data. In other embodiments, confidence values may already be associated with the suspect lists output by the fraud detection process. In such embodiments, the previously produced confidence values may be accepted, or may be rescaled according to a probability scale or using an embodiment of the method discussed with respect to step 306 (FIG. 3) or according to any other method of rescaling values known in the art.

Once confidence values have been determined for each suspect list, a voting process is performed on the suspect lists. In embodiments, the voting processes may be the process described with regard to FIG. 5. In further embodiments, any voting process known in the art may be employed. One of skill in the art will appreciate that the exact nature of the voting process has no bearing upon the embodiments disclosed herein. In embodiments, the voting process may be used to refine the confidence values previously assigned to suspect items in the multiple suspect lists. In other embodiments, the voting process may be used to calculated confidence values for the suspect items on the suspect lists. In further embodiments, the confidence values determined in using the voting process may be rescaled according to a probability scale or using an embodiment of the method discussed with respect to step 306 (FIG. 3) or according to any other method of rescaling values known in the art.

Once the confidence values for suspect items have been determined and/or refined using the voting process, the suspect items may be combined into a single suspect list. The suspect list may be ordered by confidence value. In other embodiments, the confidence value may be ordered by probability of loss. In further embodiments, the expected loss for each suspect item may be calculated. In embodiments, the expected loss may be calculated by multiplying the value associated with a suspect item by the probability of loss associated with the item. In such embodiments, the single suspect list may be ordered according to expected loss.

This disclosure described some embodiments of the present invention with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present invention. Therefore, the specific structure, acts, or media are disclosed only as illustrative embodiments. The invention is defined by the appended claims.

What is claimed is:

1. A system comprising:
at least one processor;
computer storage media storing computer-executable instructions for causing the at least one processor to perform a method of creating an ordered suspect list, the method comprising the steps of:
receiving output from the fraud detection process, wherein the output from the fraud detection process is a suspect list of suspect items and wherein each suspect item is associated with a type of suspect situation;
retrieving historically confirmed fraudulent data, wherein the confirmed fraudulent data comprises information about items previously confirmed to have been fraudulent;
retrieving historically flagged suspect data, wherein the flagged suspect data comprises information about items that have been previously flagged by the fraud detection process due to one of the suspect situations;
assigning a confidence value for each suspect item on the suspect list using the confirmed fraudulent data and the flagged suspect data; and
ordering the suspect list.

2. The system of claim 1, wherein the method further comprises:
calculating an estimate of the probability of loss for each suspect situation;
storing the calculated estimates; and
wherein assigning a confidence value comprises retrieving the stored estimates and applying the stored estimates to each suspect item.

3. The system of claim 1, wherein the fraud detection process is a transaction-based fraud detection process and wherein the historically confirmed fraudulent data comprises:
a type of suspect situation from the transaction-based fraud detection process; and
a value.

4. The system of claim 1, wherein the fraud detection process is an image-based fraud detection process, and wherein the confirmed fraudulent data comprises:
a type of suspect situation from the image-based fraud detection process; and
a value.

5. The system of claim 4 wherein the output of the image-based fraud detection process includes confidence values for the suspect items.

6. The system of claim 5, wherein the confirmed fraudulent data further comprises a confidence value from the image-based fraud detection process.

7. The system of claim 1, the method further comprising:
calculating an expected loss for each suspect item; and
further comprising ordering the suspect list based upon the calculated expected loss for each suspect item.

8. The system of claim 1, wherein ordering the suspect list further comprises ordering the suspect list based upon the assigned confidence value for each suspect item.

9. A computer implemented method for using output from a fraud detection process to produce an ordered suspect list, the computer implemented method comprising:
receiving output from the fraud detection process, wherein the output from the fraud detection process is a suspect list of suspect items and wherein each item is associated with a type of suspect situation;
retrieving historically confirmed fraudulent data, wherein the confirmed fraudulent data comprises information about items previously confirmed to have been fraudulent;
retrieving historically flagged suspect data, wherein the flagged suspect data comprises information about the frequency that each suspect situation has been previously flagged by the fraud detection process;
calculating a confidence value for at least one sub-range of suspect items on the suspect list using the confirmed fraudulent data and the flagged suspect data; and
providing the confidence value.

10. The computer implemented method of claim 9, wherein the confirmed fraudulent data comprises:
a type of suspect situation from the fraud detection system; and
a value.

11. The computer implemented method of claim 9, wherein the output from the fraud detection process includes a confidence value for each suspect item and wherein the step of assigning includes resealing the confidence values produced by the fraud detection process.

12. The computer implemented method of claim 9, further comprising:
assigning a confidence value for each suspect item on the suspect list; and
ordering the suspect list.

13. The computer implemented method of claim 12, further comprising:
calculating an expected loss for each suspect item, wherein the step of ordering comprises ordering the suspect list based upon the calculated expected loss for each suspect item.

14. The computer implemented method of claim 9, wherein the confidence value is calculated for a single sub-range that includes all items on the suspect list.

15. The computer implemented method if claim 9, wherein the confidence value is calculated for multiple sub-ranges and the sub-ranges are defined at least in part by types of suspect situations.

16. A computer implemented method for using output from first and second fraud detection processes to produce an ordered suspect list, the computer implemented method comprising:
retrieving confirmed fraudulent data, wherein the confirmed fraudulent data comprises information about items previously confirmed to have been fraudulent;
retrieving the output of the first fraud detection process, wherein the output from the first fraud detection process is a first suspect list of suspect items, and wherein each item is associated with a type of suspect situation;
retrieving a first set of historically flagged suspect data, wherein the first set of flagged suspect data relates to the first fraud detection process;
calculating a confidence value for each suspect item on the first suspect list using the confirmed fraudulent data and the first set of flagged suspect data;
retrieving the output of the second fraud detection process, wherein the output from the second fraud detection process is a second suspect list of suspect items, and wherein each item is associated with a type of suspect situation;
retrieving a second set of flagged suspect data, wherein the second set of flagged suspect data relates to the second fraud detection process;
assigning a confidence value for each suspect item on the second suspect list using the confirmed fraudulent data and the second set of flagged suspect data;
applying a voting process to the first and second suspect lists to calculate the confidence value for each suspect item; and
creating an ordered suspect list.

17. The computer implemented method of claim 16, wherein the first and second sets of flagged suspect data comprise information about the frequency of occurrence of each type of suspect reason.

18. The computer implemented method of claim 16, wherein at least one of the first and second fraud detection processes is a transaction-based fraud detection process, and wherein the confirmed fraudulent data comprises:
a type of suspect situation from the transactional-based fraud detection, wherein the type of suspect situation is associated with each fraudulent item; and
a value.

19. The computer implemented method of claim 16, wherein at least one of the first and second fraud detection processes is an image-based fraud detection process, and wherein the confirmed fraudulent data comprises:
a type of suspect situation from the image-based fraud detection system;
a confidence value from the image-based system; and
a dollar amount.

20. The computer implemented method of claim 16, further comprising:
calculating the expected loss for each suspect item; and wherein the step of ordering comprises:
ordering the suspect list based upon the calculated expected loss for each suspect item.
